(19) United States
(12) Patent Application Publication
(10) Pub. No.: US 2021/0282901 A1
(43) Pub. Date: Sep. 16, 2021

(54) ASSEMBLY FOR DENTAL RESTORATION

(71) Applicant: EUROTEKNIKA, Sallanches (FR)

(72) Inventors: Benjamin Calvat, Ugine (FR); Loïs Constant, Saint-Gervais Les Bains (FR); Benjamin Peyrot, Les Houches (FR); Théo Leger, Domancy (FR); Cédric Lancieux, Megève (FR)

(73) Assignee: EUROTEKNIKA, Sallanches (FR)

(21) Appl. No.: 16/624,847

(22) PCT Filed: Jun. 18, 2018
(86) PCT No.: PCT/EP2018/066133

§ 371 Date: Dec. 19, 2019

(30) Foreign Application Priority Data
Jun. 20, 2017 (FR) 1755618
Oct. 27, 2017 (FR) 1760122

(51) Int. Cl. A61C 8/00; A61C 9/00; A61C 13/00

(52) U.S. Cl. CPC A61C 8/008; A61C 8/0068; A61C 8/006; A61C 13/0004; A61C 8/0062; A61C 8/0069; A61C 9/0046; A61C 8/0074

(57) ABSTRACT

An assembly for dental restoration includes a healing element able to be connected to a dental implant, the healing element including a lateral surface intended to be integrated within a gum for the purpose of shaping the gum as the gum heals, and an end surface that forms, together with part of the lateral surface, an emergent surface that is intended to remain outside the gum and is asymmetrical with respect to at least one perpendicular median plane. The assembly for dental restoration also includes a detachable prosthesis support having a receiving part for a crown prosthesis and a linking part capable of engaging with a matching linking zone that is defined in a through-opening that is provided in the healing element.

The present invention relates to an assembly for dental restoration.

Dental restoration enables an artificial dentition to be produced for a patient who has lost some or all of their teeth. It is based on integrating one or more implants in the bone structure and is performed by making an incision in the gum in order to reach and to penetrate the bone structure. Thereafter, a healing element is generally fixed on an implant and this assembly remains untouched until the implant has become incorporated in the bone structure by osteo-integration and healing of the gum around the healing element. Dental restoration can be finalized by fixing a restoration abutment on the implant, on which abutment the dental prosthesis is fixed. The abutment and the dental prosthesis are individualized, adapted to the anatomy of the patient and to the tooth to be replaced, in order to achieve a result that is as close as possible to the ideal natural dentition. To this end, the precise volume of the space to be restored is generally taken into account by taking an impression, which allows individualized production of the dental prosthesis.

In the prior art, the existing methods for dental restoration encounter all or some of the following technical problems:
in many existing methods, a new intervention on the gum is performed after it has healed following implant placement, in order to take the physical or digital impression of the space to be restored, while having a view of the implant and of the gum in order to precisely take into account this overall geometry, in order to produce an abutment and a prosthesis with precise shapes: this approach is naturally traumatic;
other existing methods limit this trauma by using healing components that are not removed when an impression is taken, so as to avoid hurting the gum; however, these methods use particular healing elements, generally of a substantially cylindrical and standard shape, and sometimes incorporate indicators and/or several additional components in order to be able to take into account all or some of the geometry above the implant, without having full access thereto by taking an impression. These less traumatizing methods then have other disadvantages in terms of complexity and/or poorer optimization of the healing phase.

Thus, a general aim of the invention involves a solution for dental restoration that does not include all or some of the disadvantages of the prior art.

More specifically, a first aim of the invention is a solution for dental restoration that minimizes the trauma experienced by the patient during the restoration method.

A second aim of the invention is a solution for dental restoration that allows restoration that is adapted as closely as possible to the anatomy of the patient.

A third aim of the invention is a solution for dental restoration that is as universal as possible, adapted to any implant and any restoration.

To this end, the invention relates to an assembly for dental restoration comprising a healing element able to be connected to a dental implant, comprising a lateral surface intended to be integrated within a gum for the purpose of shaping the gum as it heals, and an end surface that forms, together with part of said lateral surface, an emergent surface that is intended to remain outside the gum and is asymmetrical with respect to at least one perpendicular median plane, characterized in that said assembly comprises a detachable prosthesis support comprising a part for receiving a crown prosthesis and a linking part capable of engaging with a matching linking zone that is defined in a through-opening that is provided in said healing element.

In other embodiments:
parts of the emergent surface that are respectively intended to be positioned oriented toward the inside and toward the outside of the mouth have a different shape;
a transverse section of the lateral surface or a projection on a parallel plane of the emergent surface has a substantially trapezoidal shape or a substantially polygonal or triangular or square or rectangular or ovoid shape, or a substantially polygonal shape with rounded corners;
a transverse section of the lateral surface or a projection on a parallel plane of the emergent surface has a part intended to be positioned oriented toward the outside of the mouth that is bigger than a part intended to be positioned oriented toward the inside;
the end surface and/or the emergent surface have a non-flat, curved surface, and/or a convex surface, and/or a smooth surface;
the healing element is a cap that comprises an opening in a surface opposite the end surface;
the linking part particularly comprises, at a free end, a fixing element, such as a first clipping component or a threaded part that is capable of engaging with said linking zone in order to establish a mechanical link;
the linking zone comprises a second clipping component, in particular a recess defined in a wall of the through-opening, that is designed to engage with a first clipping component;
the linking zone comprises a tapped part defined in a wall of the through-opening that is designed to engage with a threaded part of the fixing element of the linking part;
the receiving part of the detachable support comprises a first component provided with an internal face capable of covering all or part of the emergent surface and a second component projecting from an external face of the first component;
the linking part projects from the internal face of the first component;
the internal face comprises a cavity, defined around the linking part, having a shape that matches all or part of the emergent surface with which it is likely to come into contact;
the receiving part of the detachable support comprises a first component connecting a second component of this receiving part with the linking part;
the first component is provided with a frustoconical portion engaging with a conical bearing surface of the healing element in order to seal an interface between the healing element and the detachable support and to reduce any translational play between the healing element and the detachable support to zero;
the linking part is provided with an anti-rotation element to properly hold the detachable support on the healing element;
the detachable support comprises a hollow body while being provided with a through-hole extending longitudinally in this body from one end to the other of the detachable support;
the assembly for crown dental restoration comprises a locking element, a first end of which comprises a threaded part that is able to engage with the receiving part of the support, in particular with a wall of a through-hole defined on a second component of the receiving part that is fully or partly tapped;
the assembly for crown dental restoration comprises a locking element, a second end of which is able to engage with the linking part of the support, in particular with a first clipping component;
a second component of the receiving part comprises an external surface comprising a plurality of elements for retaining an element for bonding the crown prosthesis on this surface, in particular adhesive;
each retention element is a marker providing information relating to a maximum alteration height of the crown prosthesis;
the detachable support is produced from a polymer material, in particular from a “PEEK”, “PMMA” or even “POM” material;
the detachable support is produced using a machining and/or molding and/or material addition process;
a longitudinal axis of the support extending over its entire length is coincident with axes of rotation of the first and second components of the receiving part and of the linking part;
the detachable support comprises a longitudinal axis over its entire length that is able to be aligned with an axis of the healing element; and/or
the detachable support is a one-piece part.

The invention is more specifically defined by the claims.

Further advantages and features of the invention will become more clearly apparent from reading the description of the following preferred embodiments, with reference to the figures, provided by way of non-limiting illustrations:

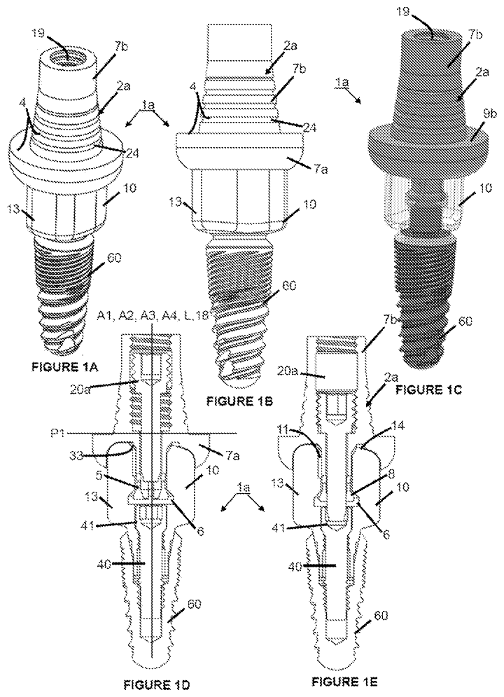

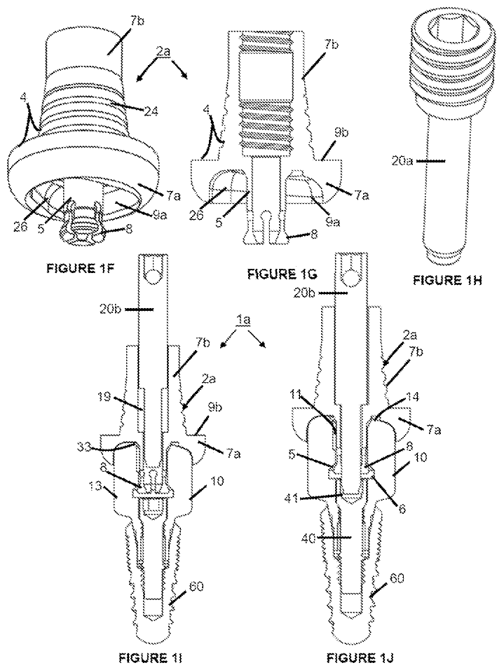

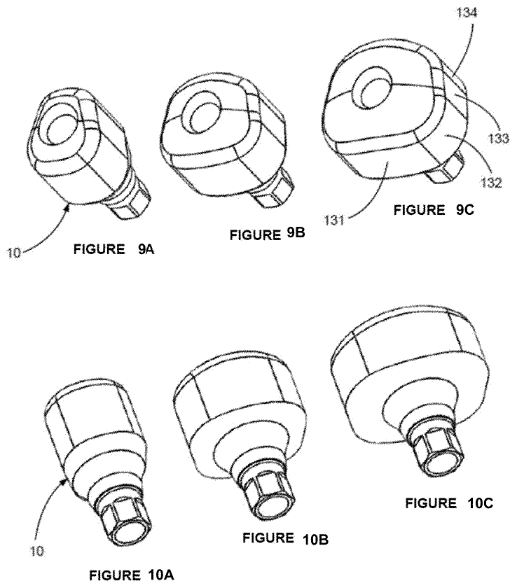

FIGS. 1A, 1B and 10 respectively show perspective views of an assembly for dental restoration comprising a healing element, an implant and a detachable prosthesis support provided with a part for receiving a prosthesis, according to a first embodiment of the invention;

FIGS. 1D and 1E respectively show longitudinal section views of the assemblies for dental restoration shown in FIGS. 1A to 1C provided with a first variant of a locking element, according to the first embodiment of the invention;

FIG. 1F shows a perspective view of the detachable prosthesis support, according to the first embodiment;

FIG. 1G shows a longitudinal section view of the detachable prosthesis support, according to the first embodiment of the invention;

FIG. 1H shows a perspective view of the first variant of the locking element, according to the first embodiment;

FIGS. 1I and 1J respectively show longitudinal section views of the assemblies for dental restoration shown in FIGS. 1A to 10 provided with a second variant of the locking element, according to the first embodiment of the invention;

FIG. 2A shows a perspective view of an assembly for dental restoration comprising a healing element, an implant and a detachable prosthesis support provided with a part for receiving a crown prosthesis, according to a second embodiment of the invention;

FIG. 2B shows a longitudinal section view of the assembly for dental restoration shown in FIG. 2A, according to the second embodiment of the invention;

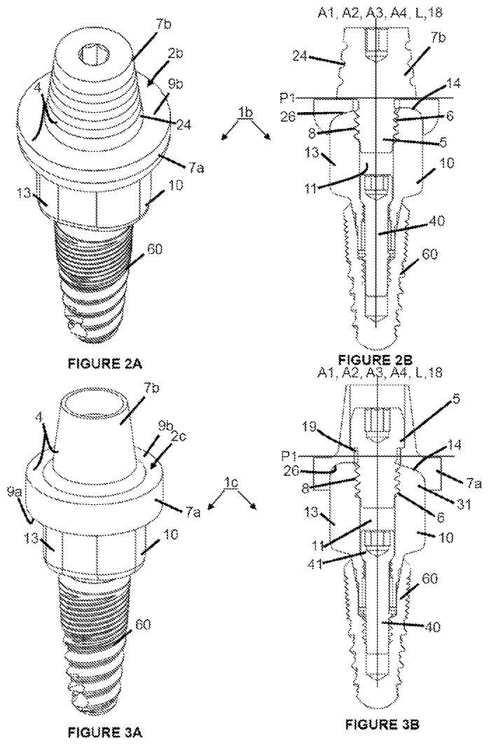

FIG. 3A shows a perspective view of an assembly for dental restoration comprising a healing element, an implant and a detachable prosthesis support provided with a part for receiving a crown prosthesis, according to a third embodiment of the invention;

FIG. 3B shows a longitudinal section view of the assembly for dental restoration shown in FIG. 3A, according to the third embodiment of the invention;

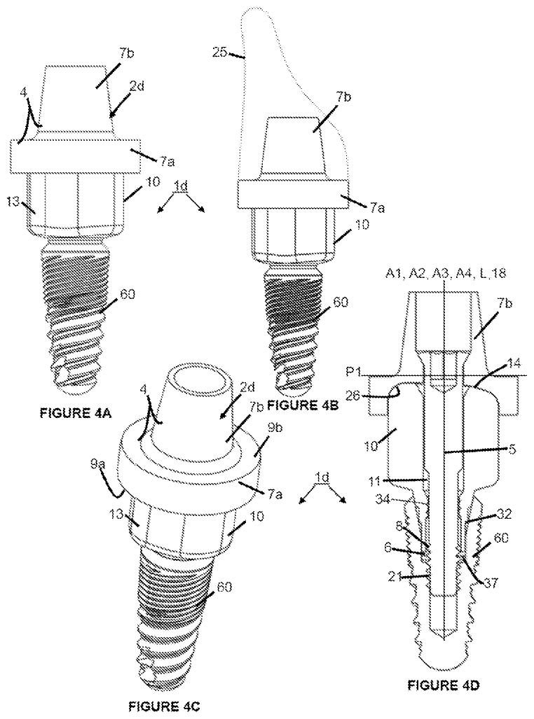

FIGS. 4A, 4B and 4C respectively show perspective views of an assembly for dental restoration comprising a healing element, an implant and a detachable prosthesis support provided with a part for receiving a crown prosthesis, according to a fourth embodiment of the invention;

FIG. 4D shows a longitudinal section view of the assemblies for dental restoration shown in FIGS. 4A to 4C, according to the fourth embodiment of the invention;

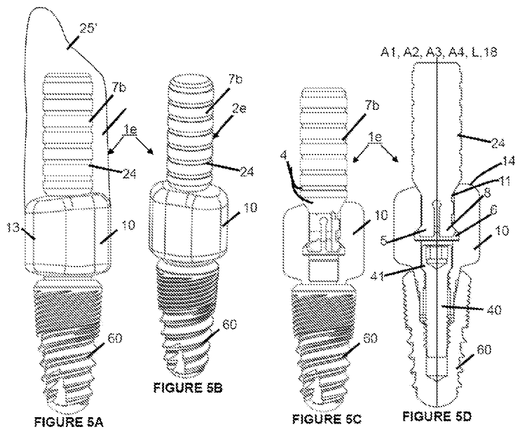

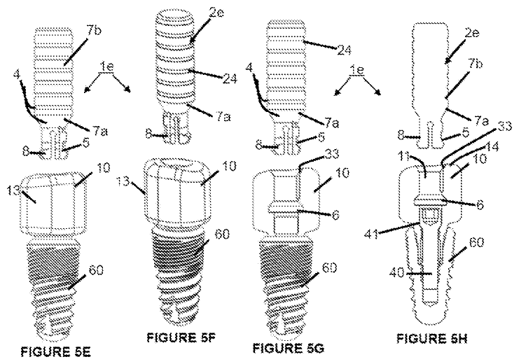

FIGS. 5A, 5B and 5C respectively show perspective views of an assembly for dental restoration comprising a healing element, an implant and a detachable prosthesis support provided with a part for receiving a crown prosthesis, according to a fifth embodiment of the invention;

FIG. 5D shows a longitudinal section view of the assemblies for dental restoration shown in FIGS. 5A to 5C, according to the fifth embodiment of the invention;

FIGS. 5E, 5F and 5G respectively show perspective views of the assemblies for dental restoration shown in FIGS. 5A to 5C with the detachable prosthesis support that is disassembled from the healing element, according to the fifth embodiment of the invention;

FIG. 5H shows a longitudinal section view of the assemblies for dental restoration shown in FIGS. 5F to 5G, according to the fifth embodiment of the invention;

FIGS. 5I, 5J, 5K, 5L and 5M respectively show perspective views of the detachable prosthesis support comprising the part for receiving the crown prosthesis, according to the fifth embodiment of the invention;

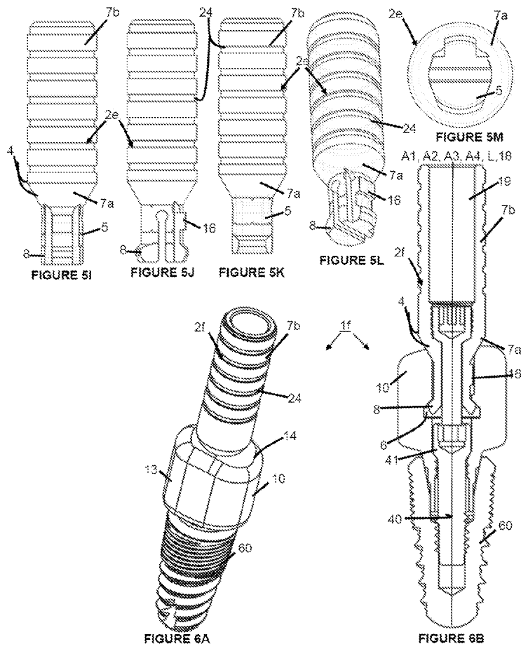

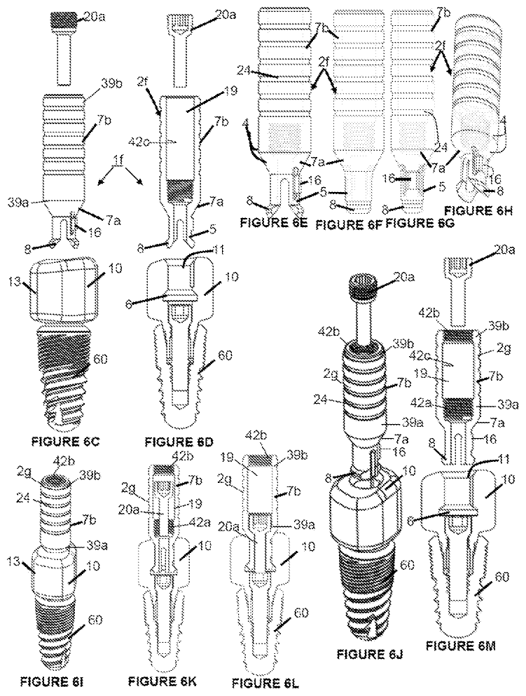

FIG. 6A shows a perspective view of an assembly for dental restoration comprising a healing element, an implant and a detachable prosthesis support provided with a part for receiving a crown prosthesis as well as a locking element, according to a sixth embodiment of the invention;

FIG. 6B shows a longitudinal section view of the assembly for dental restoration shown in FIG. 6A, according to the sixth embodiment of the invention;

FIG. 6C shows a perspective view of the assembly for dental restoration shown in FIG. 6A with the detachable prosthesis support that is disassembled from the healing element, according to the sixth embodiment of the invention;

FIG. 6D shows a longitudinal section view of the assembly for dental restoration shown in FIG. 6C, according to the sixth embodiment of the invention;

FIGS. 6E, 6F, 6G and 6H respectively show perspective views of the detachable prosthesis support comprising the part for receiving the crown prosthesis, according to the sixth embodiment of the invention;

FIGS. 6I and 6J show a perspective view of the assembly for dental restoration of FIGS. 6A to 6D comprising the healing element, the implant and a variant of the detachable support provided with a part for receiving a crown prosthesis as well as a locking element, according to a sixth embodiment of the invention;

FIGS. 6K to 6M each show a longitudinal section view of the assembly for dental restoration shown in FIGS. 6I and 6J, according to the sixth embodiment of the invention;

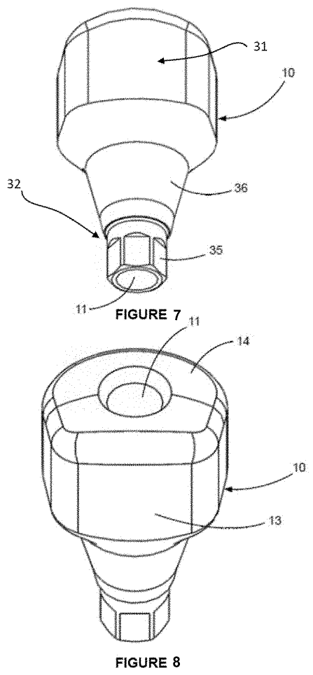

FIGS. 7 and 8 respectively show perspective bottom and top views of a healing element, according to any one of the first to sixth embodiments of the invention;

FIGS. 9A to 9C and 10A to 100 respectively show perspective top and bottom views of a series of healing elements, according to any one of the first to sixth embodiments of the invention;

FIGS. 11A to 110, 12A to 12C and 13A to 13C respectively show side, top and bottom views of a series of healing elements, according to any one of the first to sixth embodiments of the invention;

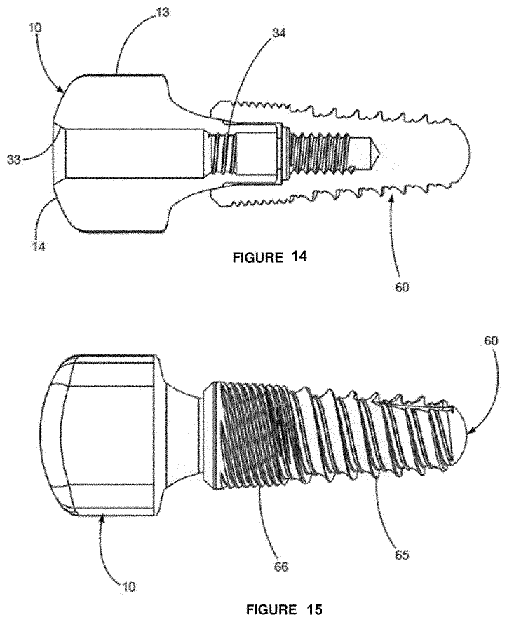

FIG. 14 illustrates a section view of a healing element disposed in an implant, according to any one of the first to sixth embodiments of the invention;

FIG. 15 illustrates a side view of a healing element disposed in an implant, according to any one of the first to sixth embodiments of the invention;

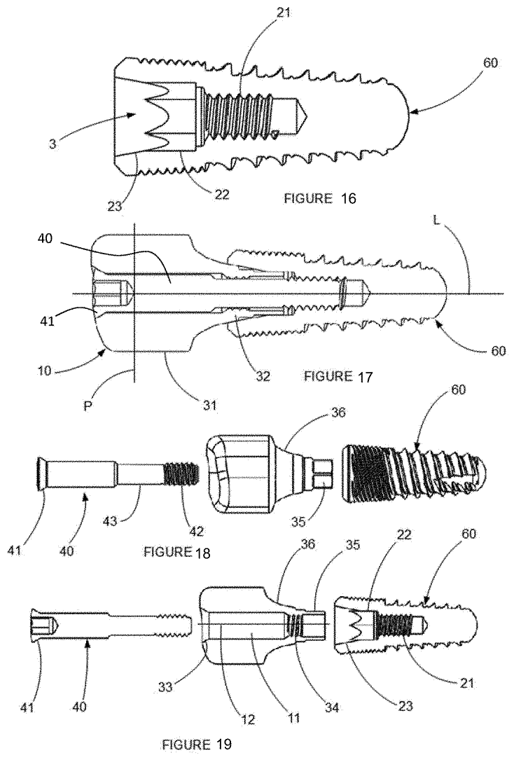

FIG. 16 shows a section view of an implant, according to any one of the first to sixth embodiments of the invention;

FIG. 17 illustrates a section view of a healing element fixed on an implant using a screw, according to any one of the first to sixth embodiments of the invention;

FIGS. 18 and 19 respectively show a side view and a section view of an intermediate phase of associating an implant with a healing element and with a screw, according to any one of the first to sixth embodiments of the invention;

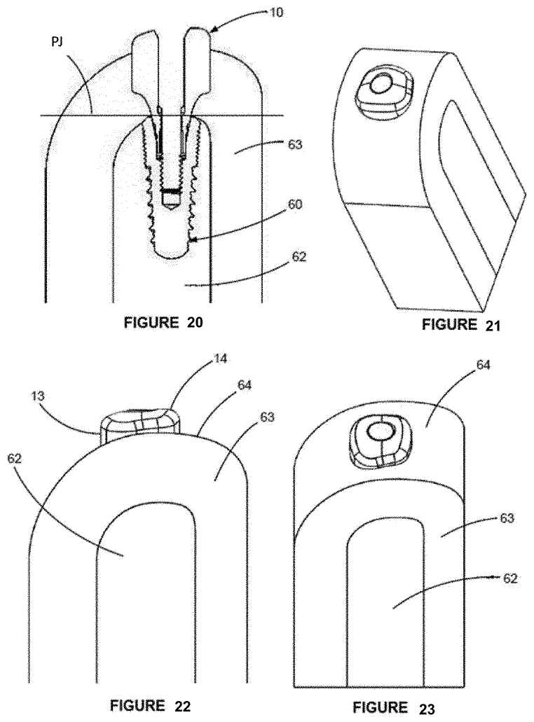

FIG. 20 illustrates a section view of a healing assembly comprising a healing element surrounded by the gum and fixed in an implant, according to any one of the first to sixth embodiments of the invention;

FIGS. 21, 22 and 23 show two schematic views of a gum as a cross-section, inside which gum a healing element is fixed, according to any one of the first to sixth embodiments of the invention;

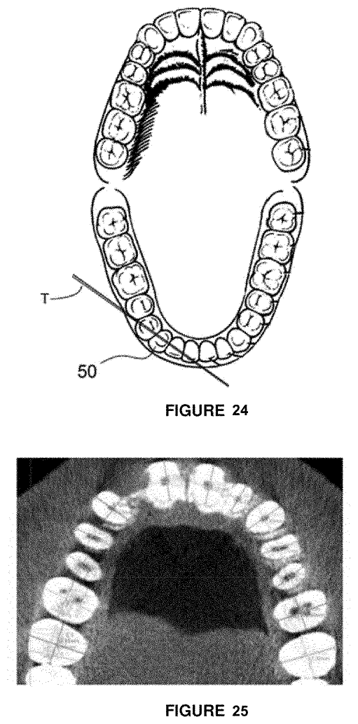

FIG. 24 shows the lower and upper teeth as a top view;

FIG. 25 shows a view of the teeth as a juxta-gingival section;

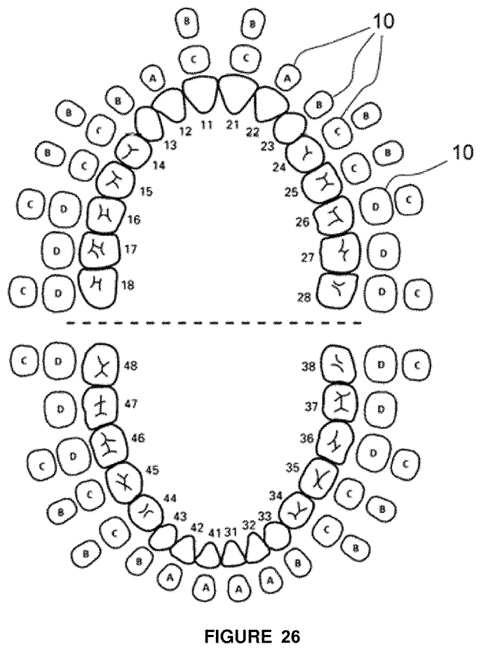

FIG. 26 shows a horizontal section of the dentition at the juxtagingival level as well as the corresponding healing elements that are used, according to any one of the first to sixth embodiments of the invention;

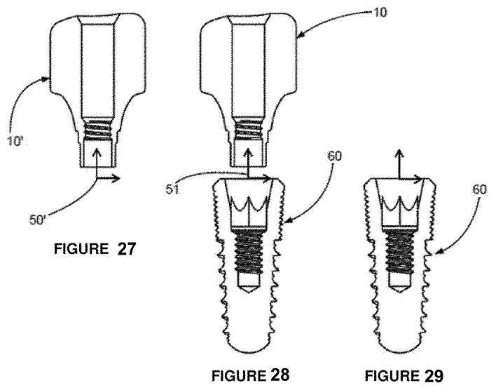

FIGS. 27 to 29 show section views through a vertical median plane, according to any one of the first to sixth embodiments of the invention.

In the embodiments shown in FIGS. 1A to 6H and 6J and 6K to 6M, the assembly 1a, 1b, 1c, 1d, 1e, 1f for dental restoration comprises a healing element able to be connected to a dental implant 60 (which will be more simply called implant 60), and a detachable prosthesis support, in particular a crown prosthesis 25, 25′. Such an assembly for dental restoration assists in the implementation of a second phase of a method for dental restoration that can comprise three phases:
a first phase, called healing phase, during which one or more implant(s) is/are integrated in the bone structure of the patient by osteo-integration and during which the particular healing element is used, as will be described hereafter;
a second phase of fitting a temporary crown prosthesis 25 on the one or more healing elements by means of the detachable support and particularly during the time required for healing; and
a third phase of restoration as such, during which a definitive crown prosthesis 25′ is fitted on the one or more implant(s) by means of a restoration abutment or even directly on the one or more healing element(s) by means of the detachable support.

It is to be noted that the second phase can be implemented during the first phase. In a particular case, the temporary crown prosthesis 25 can have features that are suitable for a definitive use and in this case the third phase is combined with the second phase.

It is to be noted that numerous situations also exist in which fitting a prosthesis during healing is not recommended, namely during the first two phases mentioned above. Indeed, such a prosthesis offers an aesthetic benefit. However, it presents a risk of inducing forces on an implant during the healing process, which can be harmful. For this reason, the healing element must be adapted for single use in the mouth, either during the first phase or during the first two phases, but also must be adapted for situations in which the addition of a prosthesis is preferred, in the first, second or third phase. Thus, the healing element can assume a first configuration, in which it receives the detachable fastener of a prosthesis support, and a second configuration, in which it is fixed by itself on an implant, without adding a prosthesis or any other component.

With reference to FIGS. 1A to 1E, 1I to 5H, 6A to 6D, 6I and 6J, and 6K to 6M and 15 to 21, the implant 60 comprises an overall shell of cylindrical or frustoconial shape and a longitudinal axis L forming an axis of rotation for this overall shell. The implant 60 comprises a means for anchoring in the bone structure of the patient. This anchoring means can be a set of threads disposed on an external periphery of the implant and comprising a variable thread pitch. A lower part of the implant, i.e. a part of the implant at the bottom of the bone structure, can comprise wider threads, while an upper part of the implant, i.e. a part of the implant at the surface of the bone structure, can comprise thinner threads. The implant comprises an opening at its upper end and along the longitudinal axis L, within which opening a connection device is located for connecting to a healing element 10. The connection device comprises a threaded opening 21, a hexagonal cross-section opening 22 in the extension of the threaded opening, and a conical bearing surface emerging on an upper face of the implant. The threaded opening 21, the hexagonal cross-section opening 22 and the conical bearing surface are adjacent, coaxial to the longitudinal axis L and arranged in such a way that the threaded opening 21 is on the lower side of the implant 60, the conical bearing surface is on the upper side of the implant 60, and the hexagonal cross-section opening 22 is between the threaded opening 21 and the conical bearing surface.

In this assembly, the healing element 10, also called “cap”, is a one-piece part, i.e. it is formed by a single part and is preferably made from a single material. It is intended to lodge inside the incised gum, after the implant has been fixed, by direct or indirect, preferably detachable, fixing on the implant.

As illustrated in FIGS. 7 to 29, the healing element 10 comprises an upper part 31 intended to be in contact with the gum and a lower part 32 intended to be introduced into the opening of the implant in order to engage with the connection device. The healing element comprises a through-opening 11 oriented along an axis and intended to receive a screw 40 screwed into the threaded opening 21 of the implant. In other words, the healing element 10 particularly comprises an opening in a surface opposite an end surface 14, which will be specified hereafter. The healing element 10 is thus intended to be fixed directly on the implant using the screw 40. When the healing element is fixed on the implant, the axis of the through-opening 11 is coincident with the longitudinal axis L of the implant. This assembly is particularly illustrated in FIGS. 17 and 20. The through-opening 11 is of generally cylindrical shape and comprises, at one end on the side of the upper part, a conical bearing surface 33. This conical bearing surface 33 is intended to engage with a conical bearing surface of a matching shaped screw head 41 so as to form a sealed interface. The conical bearing surface 33 and the screw head 41 thus fulfill the function of a sealing cone.

The healing element 10 comprises at least one thread 34 disposed at the opening 11 and able to engage with a threaded part of the screw 40 in order to prevent separation of the screw 40 and the healing element 10 through a single translational movement. The screw 40 comprises a non-threaded cylindrical part between the threaded part and the screw head 41. The threaded part is intended to cooperate with the threaded opening 21 of the implant in order to block the healing element in position. The cylindrical part of the screw is intended to be positioned along the opening 11 of the healing element. When the screw 40 is assembled with the healing element 10, the screw must be screwed through the at least one thread 34. The screw is designed so that, when the screw head 41 is in abutment on the conical bearing surface 33 of the healing element, the at least one thread 34 is opposite the cylindrical part of the screw. Advantageously, the threaded part of the screw 40 cannot be simultaneously engaged with the at least one thread 34 and the threaded opening 21 of the implant. Such an assembly of the screw, also called a “captive” assembly, avoids mistakenly separating a healing element from the screw associated therewith; for example, this assembly ensures that dropping the screw while manipulating the healing element is avoided. The healing element and the screw thus can be supplied in pre-assembled form, which reduces the number of manipulations performed by the dentist. In addition, the at least one thread 34 also constitutes an attachment point of the healing element that could be used during subsequent removal of the healing element. Indeed, the dentist can then partially unscrew the screw in order to separate its threaded part from the threaded opening 21 of the implant, while keeping the threaded part engaged on the at least one thread 34 of the healing element. The dentist can then easily grasp the screw head and pull it to remove the healing element without transferring any force to the implant and without causing discomfort to the patient.

As previously stated, in an alternative to the direct fixation of the healing element 10 on the implant 60 as previously described, said element can be indirectly fixed on this implant 60. Indeed, according to a method disclosed in document FR 3027792, this healing element 10 can be detachably fixed on an abutment base that is connected to the implant 60. In this configuration, the implant 60 is secured to the bone part, the abutment base is fixed on the implant 60, so that its collar is positioned at the boundary between the bone part and the gum. The healing element covers the abutment base as far as the collar, in such a way that the gum is almost exclusively in contact with the healing element 10. The assembly formed by assembling the healing element on this abutment base thus corresponds to a healing assembly as previously described. It is to be noted, in all cases, that the detachable support for receiving a prosthesis is separate from the healing assembly, i.e. from the two components or from the single component that it contains. In particular, the detachable support is not involved in a digital or other function for taking an impression. It is the healing assembly alone, following the removal of or in the absence of a detachable prosthesis support, that is used to take the impression, in particular a digital impression using a scanner.

In the previously described embodiment in which the healing element 10 is one-piece, it comprises, at its lower end and on an external periphery, a hexagonal cross-section portion 35 able to engage with the hexagonal cross-section opening 22 of the implant. The interface that is thus formed ensures that the healing element 10 is fixed according to a specific orientation, without rotating the healing element around the implant 60. The hexagonal cross-section portion 35 and the hexagonal cross-section opening 22 are anti-rotation elements that could be replaced by any other equivalent anti-rotation elements. Furthermore, the healing element also comprises, on the external periphery of its lower part 32, a frustoconical or substantially frustoconical portion 36 able to engage with the conical bearing surface 23 of the implant in order to form a sealed interface between the implant and the healing element. The frustoconical portion 36 comprises a boundary between the lower part 32 and the upper part 31 of the healing element. The conical bearing surface 23 and the frustoconical portion 36 fulfill the function of a sealing cone and also fulfill the function of unique positioning of the healing element with respect to the implant. Indeed, assembling the conical bearing surface 23 with the frustoconical portion 36 constitutes a pivot link with an axis coincident with the longitudinal axis L. In particular, after tightening the screw 40, such a link reduces any translational play between the healing element and the implant along the longitudinal axis L, or any axis perpendicular to the longitudinal axis L, to zero. Moreover, as rotating the healing element with respect to the implant is impossible by virtue of the interface formed by the hexagonal cross-section portion 35 and the hexagonal cross-section opening 22, the link between the healing element and the implant is a particularly rigid link.

The upper part of the healing element comprises an end face 14, through which the conical bearing surface 33 of the opening 11 emerges, and a lateral surface 13, around which the gum is intended to heal. The conical bearing surface is oriented toward the inside of the healing element such that the screw head 41 is embedded in the healing element. Thus, the screw head 41 does not protrude from the end face 14. Thus, the screw head 41 is arranged so as to close the opening 11 of the end face, while extending its surface so as to produce a continuous final surface, as is particularly shown in FIG. 17.

Existing implants can have different shapes and in particular different connection devices. There can be as many different healing elements as there are different connection devices, so as to be able to provide, for each existing implant, a healing element that is equipped with a connection device adapted thereto.

The purpose of the healing element 10 is to lodge itself within the incised gum, following the fixation of an implant. The final configuration is shown in FIG. 20. In this configuration, the implant 60 is rigidly connected to the bone structure 62 and slightly emerges from the bone part in the gum 63. The healing element 10 is fixed to the implant 60 in such a way that the gum is almost exclusively in contact with the healing element 10. The healing element assists, preferably temporarily, a restoration method, allowing healing and production without impacting the definitive crown prosthesis 25′.

The gum thus heals around the lateral surface 13 of the healing element 10. To this end, this lateral surface 13 is selected to optimally match the oral environment of the patient. The end surface 14 of the healing element is intended to remain visible above the gingival surface 64 of the gum, since the gum 63 remains fully in contact with the lateral surface 13 of the healing element. It is to be noted that the upper part of the lateral surface 13 and the end surface 14 thus form an emergent surface of the healing element. This emergent surface is particularly illustrated in FIGS. 21 to 23. To this end, healing elements of different height can be provided in order to adapt to different configurations of the oral geometry. By way of embodiments, three different standard heights enable good adaptation to all situations. This height is advantageously between 3 and 10 mm. Coloring the screw can allow the height of the healing element to be quickly identified. For example, a blue screw can be associated with a small healing element. A green screw can be associated with a medium healing element. A red screw can be associated with a large healing element. Thus, discussions between dentists and prosthetists can be simplified.

According to the embodiment of the invention, the shape of the healing element is specifically selected to promote healing of the gum, according to an anatomical shape optimally corresponding to the tooth to be replaced and therefore also to the future crown prosthesis that is intended to occupy this oral space. This shape is particularly characterized by the flat section of its lateral surface 13, with this section being a transverse section through a plane P perpendicular to the lateral surface 13, shown in FIG. 17, and substantially parallel to the end surface 14. It is to be noted that this section is substantially reproduced by the shape of the end surface 14, or, more specifically, by the projection of this end surface 14 on such a perpendicular plane, i.e. substantially parallel to the gingival surface 64.

To understand the approach that has been used, FIG. 24 illustrates a top view of the upper and lower teeth, and FIG. 25 illustrates a section view of the juxta-gingival plane PJ of a dentition, shown in FIG. 20, at the root of emergences of the teeth. These figures show that the teeth have different shaped cross-sections, which can be simplified by rectangular shapes and/or square shapes and/or triangular shapes, but, more specifically, by trapezoidal shapes.

According to the selected embodiment, a series of healing elements 10 with different shapes will allow optimal reproduction of these different shapes. FIG. 26 thus shows a top view of the cross-sections of all the teeth and a top view of healing elements 10 associated with each tooth. The shapes of the different series of teeth, numbered from 11 to 18, 21 to 28, 31 to 38 and 41 to 48 in this figure (these numbers are not to be confused with the numerical reference signs used elsewhere in the other figures to designate the features of the invention), are all approached by means of four different healing elements 10, designated A to D. For some teeth, or indeed for all the teeth, several healing elements from among the healing elements A to D appear to be suitable.

In the embodiment selected and illustrated in FIG. 26, the healing elements A are adapted to treat the restoration of the upper lateral incisors and all the lower incisors. The healing elements B are adapted to restore canines and premolars, the healing elements C are adapted to restore intermediate molars, then the healing elements D are adapted to restore larger molars. By way of a variant, the series of healing elements 10 could comprise any other number of different healing elements, for example, three or five different healing elements.

These healing elements will now be described in further detail by considering a series of three healing elements A, B and C. The healing element A is particularly illustrated in FIGS. 9A to 13A, the healing element B in FIGS. 9B to 13B, and the healing element C in FIGS. 9C to 13C. To avoid overcomplicating the figures, the numerical reference signs are not reproduced on all the healing elements of these figures. However, all these healing elements have the same features, which will be described.

As can be seen from FIGS. 9C to 12C, the end surfaces 14 of these healing elements 10 (A to C), intended to be positioned above the gingival emergence, are substantially flat and are intended to be positioned parallel to a horizontal plane (parallel to the juxta-gingival plane PJ, between 1 and 2 mm inclusive above this plane) corresponding to the cutting plane of FIG. 24. However, they are slightly curved, having a central part 145, which is more particularly shown in FIGS. 11A to 11C, intended to rise further above the gum than its peripheral parts 146.

The transverse section of the healing element, through a plane P perpendicular to its lateral surface 13, as previously explained, which provides the final shape of the gum after healing, is substantially reproduced by the end surface 14 of the healing element (particularly its projection on a plane P), which lies in its extension. The cross-sections of all the healing elements all have a substantially trapezoidal shape. They have a long side 141, which will be disposed on the outside of the mouth (vestibular side), and a short side 142 parallel and opposite thereto, which will be disposed on the inside of the mouth (lingual side), which are connected by two sides 143, 144. The intersection of the diagonals of the trapezium allows a center 15 to be defined. Preferably, this center 15 thus defined is located on the axis of the through-opening 11 of the healing element. Furthermore, by considering the same center 17 of the opening 11 at the lower end of the healing element in the alternative of a restoration assembly with several separate, substantially circular, elements, it is possible to define a central axis 18 of the healing element passing through the two central points 15, 17. This axis 18 of the healing element 10 is perpendicular to the end surface 14. Preferably, the axis 18 of the healing element, whether or not it is one-piece, is coincident with the axis of the through-opening 11 and the longitudinal axis L of the implant.

The three types of healing elements 10 (A, B and C) therefore particularly differ in terms of the trapezoidal shape of the transverse section of their lateral surfaces 13. Depending on the considered healing element, the trapezoidal shape can resemble a triangular shape or a rectangular shape, or even a square shape. By way of embodiments, FIGS. 13A to 13C provide orders of magnitude of the dimensions of these healing elements, in millimeters.

Of course, this substantially trapezoidal shape that is used has rounded corners and curved sides, so as to ensure that the gum is not hurt. Moreover, the end surface 14 of each healing element has, except for the opening 11, a continuous surface without raised portions and/or without a hollow section and/or without a recess and/or without a ridge and/or without roughness. This surface is convex. This smooth geometry promotes oral hygiene, and reduces the accumulation of food and deposits of dental plaque. It is to be noted that, when the healing element is fixed by itself on an implant by means of a screw 40, the head 41 of the screw completes the end surface 14, which becomes substantially continuous, even at the opening 11. Thus, this surface that is closed by the screw head then substantially exhibits the property of a continuous surface, without a raised portion and/or without a hollow section, and/or without a recess, and/or without a ridge, and/or without roughness. This architecture makes the use of a single healing element optimal. In addition, the seal is provided at the interface between the head 41 of the screw 40 and the end surface 14.

By way of a variant, the series of healing elements could comprise a different number of different geometries, for example, at least two. In a simplified alternative embodiment, a single healing element shape could be suitable for all the teeth.

According to other alternative embodiments, the transverse section of a healing element, at its lateral surface 13, could be similar to any polygon, such as a polygon with three, five or six sides. By way of a variant, the corners of these polygons could be so rounded that the overall shape would resemble an oblong shape, even with an ovoid cross-section, or any other shape further removed from a polygon. Advantageously, this shape comprises at least one center or point that is perfectly geometrically defined in order to define a center 15, or a possible axis 18, of the healing element. This transverse section is obtained by a cutting plane substantially parallel to the juxta-gingival plane.

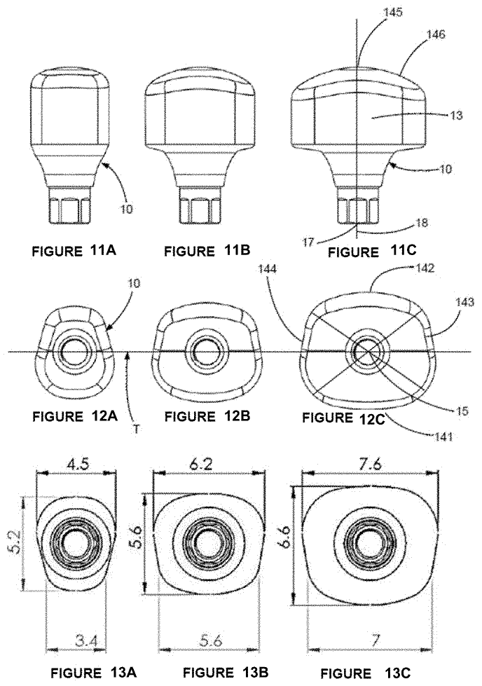

According to the embodiment, the geometry of the visible emergent surface of the healing element on the inside of the mouth differs from the geometry on the outside, so as to take into account the curvature of the gum. This shape of the emergent surface of the healing element is thus asymmetrical with respect to a median plane containing the tangent T to the gum, shown in FIGS. 12A to 12C, and more specifically in FIG. 24, in relation to a tooth 50 to be restored. This median plane, called tangent plane T, is parallel to the tangent T to the gum, perpendicular to the juxta-gingival plane PJ and passes through the middle 15 of a healing element. In other words, the geometry of the visible emergent surface of the healing element on the inside of the mouth differs from the geometry on the outside, so as to take into account the curvature of the gum or the natural shape of the teeth. In particular, the height along the longitudinal axis of the healing element on the lingual side, i.e. on the inside of the mouth, can be greater than the height of the healing element on the outside of the mouth. The shape of the emergent surface of the healing element is therefore asymmetrical relative to a plane parallel to the longitudinal axis and passing through the center 113 of the end surface 111. On the one hand, this asymmetry can be characterized by different shapes of the healing element on either side of the plane while considering a projection of the healing element on a plane perpendicular to the longitudinal axis. On the other hand, this asymmetry can be characterized by different heights of the healing element on either side of the plane. An example of such asymmetry is particularly shown in FIG. 20.

Thus, a circular shape for the cross-section of a healing element, associated with a cylindrical healing element, for example, is unsuitable. More generally, any flat curve exhibiting symmetry about a point or an axis is hardly suited or is ill-suited to the aforementioned cross-section of the healing element, since, on the one hand, it would not be adapted to the anatomy of the mouth and, on the other hand, its circular orientation about this axis would no longer be identifiable. For the same reasons, the emergent and visible surface of the healing element therefore is not symmetrical with respect to at least one or even several planes parallel to its axis 18, and/or comprising this axis 18. It is not symmetrical with respect to at least one or several planes perpendicular to the emergent surface and passing through its center 15 or comprising the axis 18, which are referred to as perpendicular median planes. In the example shown, only the plane perpendicular to the aforementioned tangent plane T, passing through the middle of the two sides 141, 142, forms a plane of symmetry. The preceding observations apply to the emergent surface of the healing element, or to its transverse section through a previously defined cutting plane P, or to the projection of its emergent surface on such a plane P (parallel to the juxta-gingival plane). The perpendicular median plane is then any plane perpendicular to the plane P and passing through the center of the considered geometry of the healing element.

Alternatively, a perpendicular median plane can be defined as any plane containing the axis 18 of the healing element. This emergent surface of a healing element finally can assume any identifiable three-dimensional shape, allowing the healing element that is used to be recognized and optionally its orientation to be known, in order to fulfill a second function that will be described hereafter.

The end surfaces 14 of the healing elements are extended, from their periphery 146, by the lateral surface 13 around which the gum heals, and which thus provides the gum shape adapted to the future crown prosthesis. This lateral surface 13 has a plurality of surfaces 131, 132, 133, 134, which are substantially flat and optionally are slightly curved, extending in a direction substantially parallel to the axis 18 of the healing element and/or parallel to the longitudinal axis L of the implant, by respectively extending the different sides 141, 142, 143, 144 of the end surface 14 of the healing element. The interfaces between the end surface 14 and these different parts of the lateral surface 13 are formed by smooth rounded surfaces, in particular convex surfaces.

The healing element can be made of plastic material compatible with medical use and having a pink, white or cream color. In particular, the healing element can be produced from a polymer material, in particular from a “PEEK” material. By way of a variant, it can be made of metal, for example, of titanium, or can be made of zirconium. Effectively, this healing element 10 can be made of titanium with a surface treatment produced from zirconium nitride in order to particularly improve the visibility of this element 10 using oral scanners, yet while being biocompatible. The healing element can be produced by machining and/or by molding and/or by the addition of material, in other words by 3D printing.

The use of healing elements thus allows ideal healing of the gum to be promoted within the context of a method for dental restoration, due to its geometry that is designed in line with the oral anatomy. It is to be noted that this healing element can, by way of a variant, be completely sub-gingival and invisible, then rendered visible through intervention on the gum. In this case, the end part of the healing element will always be incorrectly called the emergent part.

Furthermore, the emergent surface of the healing element 10, formed by the end surface 14 and optionally by the upper part of the lateral surface 13, advantageously can comprise at least two informative markers for identifying at least two features of the healing element 10 and/or indirectly of the abutment base and/or of the dental implant 60. The arrangement of such informative markers on the healing element 10 avoids having to use a conventional technique for taking an impression on the implant and reduces the time required for and the complexity of subsequently setting up either the abutment for dental restoration that will be fitted as a replacement for the healing element 10, and on which the final prosthesis will be arranged, or the definitive crown prosthesis 25′ that will be fitted as a replacement for the temporary crown prosthesis 25. It is to be noted that these markers are optional since, according to an alternative embodiment, the single shape of the emergent surface of the healing element will suffice for automatic identification of the same information, due to the specific asymmetric shape of this emergent surface. Therefore, it is worthwhile properly differentiating the solution with a marker compared to not using a marker:
a marker is defined as a symbol or a specific shape, intended for the recognition thereof, the sole purpose of which is this recognition; the marker is generally specifically designed to be easily recognized by a scanner. It generally has no impact or a negative impact on the main healing function of the healing element:
the alternative to the invention involves not using a marker, but recognizing the particular shape of the healing element, in particular its end part, in order to deduce desired information therefrom. In this case, the recognized shape initially has the main technical function of anatomical healing. The invention benefits from this anatomical nature in order to dispense with a marker. Recognition is more difficult with this alternative, but it offers the advantage of not deteriorating the ideal shape designed for healing, with the secondary aim of forming an indicator. The solution of this alternative without a marker, or with less markers (compared to a solution that is solely based on markers), is therefore advantageous and preferred.

According to one embodiment, the features identified by the informative markers comprise one or more elements from among:
the height of the healing element 10;
the shape of the healing element 10, in particular the shape and the dimensions of the transverse section of its lateral surface 13 or of the projection on a parallel plane of the emergent surface;
the dimensions of the linking part of the healing element 10, with or without an abutment base, and therefore of the dental implant 60;
the orientation of the dental implant 60, by means of the orientation of the cap, for example, by a marker aligned with an anti-rotation element of the cap.

According to a particular embodiment, said at least two informative markers comprise a first type of informative marking of a first feature of the healing element 10 and a second type of informative marking of a second feature of the healing element 10. These first and second features associated with the healing element 10 are, in particular, the height of the healing element 10 and/or the shape of the healing element 10, in particular the shape and the dimensions of the transverse section of its lateral surface 13 or of the projection on a parallel plane of the emergent surface. Indirectly, a marker can allow information to be determined relating to the abutment base, when there is one, and optionally relating to the implant, such as their orientation, which can be associated with the orientation of the healing element.

Without being limiting with respect to the design freedom for the informative markers, each informative marker particularly belongs to one of the following types:
a negative informative marker, in particular hollowed out of one of the surfaces of the healing element 10, particularly on its emergent surface;
a positive informative marker, in particular as a raised portion on one of the surfaces of the healing element 10, particularly on its emergent surface;
an informative marker with a specific and identifiable shape formed in one of the surfaces of the healing element 10, in particular of polygonal or line shape;
an informative marker formed by a readable digital value or by a readable identification code, such as a bar code and/or a data matrix code. This marker can be made up of numbers and/or of letters and/or of any symbol and/or of colors and or/of laser markings:
an informative means formed by an RFID chip.

As previously seen, this assembly 1a to 1f for dental restoration comprising a healing element 10 able to be connected with a dental implant 60, comprises the detachable prosthesis support 2a to 2g, which is also sometimes simply referred to as “support”. This detachable support 2a to 2g comprises a part 4 for receiving a temporary crown prosthesis 25 (shown in FIG. 4B) and/or a definitive crown prosthesis 25′ (shown in FIG. 5A). The receiving part 4 is provided with a first and a second component 7a, 7b and with a linking part 5, particularly shown in FIGS. 1F and 1G.

This linking part 5 is capable of engaging with a corresponding linking zone 6 defined in the through-opening 11 arranged in the healing element 10. Effectively, such a linking part 5, which allows this support 2a to 2g to be detachably mechanically connected to the healing element 10, particularly comprises, at a free end, a fixing element 8, such as a first clipping component, in particular a male clipping component, or a threaded part. Within this context, when the linking part 5 comprises the first clipping component, said component is then able to engage with a linking zone 6, such as a recess/groove defined in the wall of the through-opening 11 of the healing element 10, in order to establish this mechanical link. It is to be noted that such clip-on fixing allows the detachable support 2a to 2g to be able to be easily mounted on and removed from the healing assembly several times when the crown prosthesis 25, 25′ is produced on the detachable support 2a to 2c and this is in order to be able to perform polishing and/or alteration operations outside the mouth of the patient. It is to be noted that, in a variant in which this fixing element 8 of the linking part 5 comprises a threaded part, said part is then able to engage with a linking zone 6 such as a tapped part defined in the wall of the through-opening 11 in order to establish this mechanical link.

In the first embodiment shown in FIGS. 1A to 1E and 1I, the detachable support 2a is a one-piece part provided with a central, generally cylindrical through-hole 19 extending longitudinally in this body from one end of the detachable support 2a to the other. The first component 7a of the receiving part 4 is provided with internal and external faces 9a, 9b and with a basically round peripheral wall connecting these faces 9a, 9b together. In this configuration, the second component 7b projects from a central region of the external face 9b of the first component by extending longitudinally along an axis A3 that is substantially perpendicular to a plane P1 comprising this external face 9b. This second component has a basically frustoconical or even cylindrical shape and comprises an external surface provided with a plurality of elements 24 for retaining an element for bonding the crown prosthesis 25, 25′ on the receiving part 4 and therefore on this surface. When this bonding element is adhesive, for example, each retention element 24 can be a cavity, a groove, a hole or even a bump. It is to be noted that each retention element 24 also can be a marker providing information relating to a maximum alteration height of the crown prosthesis and/or of the support. In addition, part of the through-hole 19 of the detachable support 2a, defined on this second component 7b, comprises a wall that is fully or partly tapped.

In this detachable support 2a, the linking part 5 projects in a central region of the internal face 9a of the first component 7a. This linking part 5 is particularly designed to be inserted into the through-opening 11 of the healing element 10 when the detachable support 2a is assembled on this healing element 10. This linking part 5 comprises a frustoconical or substantially frustoconical portion able to engage with the conical bearing surface 33 of the healing element 10 in order to form a sealed interface between the detachable support 2a and the healing element 10. Such a linking part 5 comprises, at its free end, the fixing element 8, such as the first clipping component. According to this embodiment, this first clipping component is included at an end of the through-hole 19 of this detachable support 2a and comprises a plurality of flexible fins, in this case two, three or four fins, arranged around the axis of the through-hole 19, as far as its lower end. These fins are spaced apart from each other by a substantially similar gap caused by a hollowing out of material. Such fins are able to transition from a rest position to a constrained position when they are substantially radially moved. These fins each have a shape that matches the linking zone 6, such as the recess with which they are likely to engage in order to establish this clip-on fixing.

In this detachable support 2a, the internal face 9a of the first component 7a is particularly provided to cover all or part of the emergent surface of the healing element 10 and in particular preferably the entire end surface 14 and part of the lateral surface 13 adjoining this end surface 14, as shown in FIGS. 1I and 1J. Thus, the internal face 9a comprises a cavity 26 defined around the linking part 5, which has a shape that matches that of all or part of the emergent surface with which it is likely to come into contact.

In this first embodiment, the assembly 1a for dental restoration can comprise a locking element 20a, 20b for stiffening the detachable support 2a, comprising a body provided with first and second ends and having a generally cylindrical shape. With reference to FIG. 1H, this locking element 20a, 20b can be, for example, a screw 20a comprising a head and a shaft. The head is then included in the first upper end of the body of this locking element 20a and comprises a threaded part that is able to engage with the receiving part 4, in particular with an internal wall of the through-hole 19 defined on the second component 7b, which is fully or partly tapped. Alternatively, with reference to FIGS. 1I and 1J, this locking element 20a, 20b can be a shaft 20b, for which part of the body projects from the through-hole 19 in the vicinity of the second component 7b of the receiving part 4, when said shaft is arranged in the assembly 1a for dental restoration. Such a locking element 20a, 20b is designed to be inserted into the assembly 1a for dental restoration by passing through the through-hole 19 of the detachable support 2a and entering the through-opening 11 of the healing element 10, in order to activate the flexible fins of the first clipping component so that they thus move from the rest position to the constrained position. By thus being in the constrained position, a larger part of these fins is then arranged in the recess defined in the wall of the through-opening 11 and/or the withdrawal of these fins is impossible, which thus fulfills the function of locking the assembly of the detachable support 2a with the healing element 10, even with the healing assembly formed by the implant 60 and the healing element 10. Within this context, only the removal of this locking element 20a, 20b from the through-hole 19 and from the through-opening 11 thus allows the fins to be disengaged from said recess. It is to be noted that the locking element 20a, 20b is inserted into the through-hole 19 until its second end, which also passes through the through-opening 11 of the healing element 10, is arranged in a housing defined in the screw head 41 of the screw 40 mechanically connecting the healing element 10 to the implant 60. Thus, in such an arrangement of the locking element 20a, 20b in the assembly 1a for dental restoration, the body of this locking element 20a, 20b is then included between the flexible fins that are held in the clip-on fixing position. It is to be noted that when this locking element 20a, 20b corresponds to the screw 20a shown in FIG. 1H, its first upper end is included in the through-hole 19 and its second lower end is located in the through-opening 11 of the healing element 10, in particular in the housing defined in the screw head 41 of the screw 40 mechanically connecting the healing element 10 to the implant 60.

In the second embodiment shown in FIGS. 2A and 2B, the detachable support 2b, unlike the support of the first embodiment, which is one-piece, comprises two separate parts. In this configuration, the first part corresponds to the first component 7a of the receiving part 4, which is provided with internal and external faces 9a, 9b and with a basically round peripheral wall connecting these faces 9a, 9b together. It also comprises a central opening, in which the second part is able to be inserted that defines the second component 7b and the linking part 5 of the detachable support 2b. Thus, when the two parts are assembled together to form the detachable support 2b, by being mounted on the healing element 10, the second component 7b then projects from a central region of the external face 9b of the first component 7a by extending longitudinally along an axis A3 that is substantially perpendicular to a plane P1 comprising this external face 9b. This second component 7b has a basically frustoconical or even cylindrical shape and comprises an external surface provided with a plurality of elements 24 for retaining an element for bonding the crown prosthesis on the receiving part 4 in a similar manner to the first embodiment. It is to be noted that each retention element 24 also can be a marker providing information relating to a maximum alteration height of the crown prosthesis and/or of the support.

In addition, the linking part 5 projects in a central region of the internal face 9a of the first component 7a. This linking part 5 is particularly designed to be inserted into the through-opening 11 of the healing element 10 when the detachable support 2b is assembled on this healing element 10. Such a linking part 5 comprises, at its free end, the fixing element 8, in this case a threaded part. This threaded part is able to engage with the tapped part defined in the wall of the through-opening 11 in order to establish this mechanical link between the detachable support

1. An assembly for dental restoration comprising:
a healing element able to be connected to a dental implant, the healing element including a lateral surface intended to be integrated within a gum for a purpose of shaping the gum as the gum heals, and an end surface that forms, together with part of the lateral surface, an emergent surface that is intended to remain outside the gum and is asymmetrical with respect to at least one perpendicular median plane, and
a detachable prosthesis support having a receiving part for a crown prosthesis and a linking part capable of engaging with a matching linking zone that is defined in a through-opening that is provided in the healing element.

2. The assembly as claimed in claim 1, wherein the healing element can assume a first configuration, in which the healing element is connected to the detachable prosthesis support, and a second configuration, in which the healing element is fixed by itself to the implant using a screw without the detachable prosthesis support.

3. The assembly as claimed in claim 2, wherein in the second configuration, a head of the screw is embedded in the healing element and does not exceed the end surface of the healing element.

4. The assembly as claimed in claim 1, wherein parts of the emergent surface of the healing element that are respectively intended to be positioned oriented toward an inside and toward an outside of a mouth have a different shape.

5. The assembly as claimed in claim 1, wherein a transverse section of the lateral surface of the healing element or a projection on a parallel plane of the emergent surface of the healing element have:
a substantially trapezoidal shape or a substantially polygonal or triangular or square or rectangular or ovoid shape, or a substantially polygonal shape with rounded corners; and/or
a part intended to be positioned oriented toward an outside of a mouth that is bigger than a part intended to be positioned oriented toward an inside of the mouth.

6. The assembly as claimed in claim 1, wherein the end surface and/or the emergent surface of the healing element have:
a non-flat, curved surface; and/or
a convex surface; and/or
a smooth surface, or
wherein the end surface and/or the emergent surface of the healing element, supplemented by a head of a screw when the healing element is fixed by itself using the screw has a continuous surface, without raised portions, and/or without a hollow part, and/or without a recess, and/or without a ridge, and/or without roughness and/or is convex.

7. The assembly as claimed in claim 1, wherein the emergent surface of the healing element has an identifiable three-dimensional shape capable of automatically enabling recognition, positioning, and/or orientation of the healing element, and indirectly recognized the positioning and the orientation of the implant, without a marker.

8. The assembly as claimed in claim 1, wherein the linking part of the detachable support comprises, at a free end, a fixing element that is a first clipping component or a threaded part, that is capable of engaging with a linking zone of the healing element in order to establish a mechanical link.

9. The assembly as claimed in claim 8, wherein the linking zone of the healing element comprises:
a second clipping component includes a recess, defined in a wall of the through-opening, the recess being designed to engage with the first clipping component; or
a tapped part defined in a wall of the through-opening that is designed to engage with a threaded part of the fixing element of the linking part.

10. The assembly as claimed in claim 1, wherein the receiving part of the detachable support comprises a first component provided with an internal face capable of covering all or part of the emergent surface of the healing element and a second component projecting from an external face of the first component.

11. The assembly as claimed in claim 10, wherein the linking part projects from the internal face of the first component.

12. The assembly as claimed in claim 11, wherein the internal face comprises a cavity, defined around the linking part, having a shape that matches all or part of the emergent surface of the healing element with which it is likely to come into contact.

13. The assembly as claimed in claim 1, wherein the receiving part of the detachable support comprises a first component connecting a second component with the linking part.

14. The assembly as claimed in claim 10, wherein the first component is provided with a frustoconical portion engaging with a conical bearing surface of the healing element in order to seal an interface between the healing element and the detachable support and to reduce any translational play between the healing element and the detachable support to zero.

15. The assembly as claimed in claim 1, wherein the linking part is provided with an anti-rotation element to properly hold the detachable support on the healing element.

16. The assembly as claimed in claim 1, wherein the detachable support comprises a through-hole extending longitudinally from one end to another end of the detachable support.

17. The assembly as claimed in a claim 1, comprising:
a locking element, wherein a first end of the locking element includes a threaded part that is able to engage with the receiving part of the detachable support with a wall of a through-hole defined on a second component of the receiving part that is fully or partly tapped.

18. The assembly as claimed in claim 1, comprising:
a locking element, and
a second end of the locking element is able to engage with the linking part of the detachable support with a first clipping component.

19. The assembly as claimed in claim 1, wherein a second component of the receiving part of the detachable support comprises an external surface comprising a plurality of elements for retaining an adhesive for bonding a crown prosthesis on the external surface.

20. The assembly as claimed in claim 19, wherein each retention element is a marker providing information relating to a maximum alteration height of the crown prosthesis.

21. The assembly as claimed in claim 1, wherein the detachable support is produced from a polymer material from a “PEEK”, “PMMA” or “POM” material.

22. The assembly as claimed in claim 1, wherein the detachable support is produced using a machining and/or molding and/or material addition process.

23. The assembly as claimed in claim 1, wherein a longitudinal axis (A1) of the detachable support extending over an entire length of the detachable support is coincident with axes of rotation of a first and second components of the receiving part and of the linking part.

24. The assembly as claimed in claim 1, wherein the detachable support comprises a longitudinal axis (A1) extending over an entire length of the detachable support that is able to be aligned with an axis of the healing element.

25. The assembly as claimed in claim 1, wherein the detachable support is a one-piece part and/or the healing element is a one-piece part.

26. A system for dental restoration, comprising;
the assembly for dental restoration as claimed in claim 1,
a scanner for taking a digital impression, and
at least one computer that uses images originating from taking a digital impression for automatic recognition, on a basis of an anatomical shape of the healing assembly and/or by recognizing at least one marker, of the type of healing element that is used, the system using the restoration assembly in a second configuration, in which only the healing assembly is digitized in an oral space.
